(19) United States
(12) Patent Application Publication
(10) Pub. No.: US 2012/0234918 A1
(43) Pub. Date: Sep. 20, 2012

(54) CARD READER DEVICE FOR A CELL PHONE AND METHOD OF USE

(76) Inventor: Peter R. Lindsay, Chardon, OH (US)

(21) Appl. No.: 13/422,468

(22) Filed: Mar. 16, 2012

Related U.S. Application Data
(60) Provisional application No. 61/453,137, filed on Mar. 16, 2011.

(51) Int. Cl. G06K 7/08

(52) U.S. Cl. 235/449

(57) ABSTRACT

A secure device for reading a card having data stored on a magnetic stripe incorporated into a card. The card reader device reads and then encrypts the data, then outputs an analog signal that is indicative of the encrypted data. By way of an electrical plug-and-jack connection to a cell phone, the output signal is passed to circuitry in the cell phone where it is processed to extract the encrypted data. For security purposes, the cell phone is not enabled to decrypt the data, and therefor transmits the encrypted data to a remote server that is so enabled. When the card is used for financial transactions, the remote server cooperates with appropriate financial systems to process the transaction using data from the card plus transaction details that were entered by the cell phone user.

### CROSS-REFERENCE TO RELATED APPLICATIONS

This application claims the benefit of U.S. Provisional Patent Application No. 61/453,137, filed Mar. 16, 2011 by Peter R. Lindsay, which is incorporated in its entirety by reference herein.

### BACKGROUND

This disclosure relates to a card reader device for use with a cellular phone for reading a magnetic stripe card and more particularly to a portable card reader device which senses the magnetically recorded information stored on a magnetic stripe card and conveys this sensed information via an analog waveform to a cell phone for further processing.

This disclosure further relates to an improvement wherein the sensed information is encrypted for providing security. Said improvement is disclosed as apparatus and method steps that are added to those disclosed in U.S. Pat. No. 7,810,729 granted to Morley, Jr. on Oct. 12, 2010.

Plastic cards having a magnetic stripe embedded on one side of the card are prevalent in every day commerce. These cards are used in various transactions such as to pay for purchases by using a credit card, a debit card, or a gasoline charge card. A charge card or a debit card may also be used to transact business with a bank through use of an automated teller machine (ATM). The magnetic stripe card is capable of storing data by modifying the magnetism of magnetic particles embedded in the stripe. The data stored on the magnetic stripe may be sensed or read by swiping the stripe past a read head. The analog waveform obtained by sensing the magnetic stripe must undergo a process known as decoding to obtain the digital information stored in the magnetic stripe of the card. Conventional magnetic stripe card readers are comprised of both relatively simple sensing components as well as the more costly and complex decoding and communication components.

It is typical in a magnetic stripe card to locate the magnetic stripe 0.223 inches from an edge of the card with the stripe being 0.375 inches wide. The magnetic stripe contains up to three tracks of digital data with each track being 0.110 inches wide. Tracks one and three are typically recorded at 210 bits per inch, while track two typically has a recording density of 75 bits per inch. Each track can either contain 7-bit alphanumeric characters, or 5-bit numeric characters. Track one standards were created by the airlines industry, the International Air Transport Association. Track one can contain information reserved for the bank that issued the card and magnetically encoded data like the primary account number, the user's name, a country code, an expiration date for the card, and 79 characters of discretionary data, all mixed in with separators and other specialized computer characters. The second track, the track most commonly used, is in a format defined by the American Bankers Association. The second track can contain the primary account number, the country code, the card's expiration date, 40 characters of discretionary data, and separator characters. The third track is in a format called THRIFT and was originally intended for use with ATMs. Unlike tracks one and two, which are read only tracks, the third track was intended for read and write applications. However, for the most part, the third track is hardly ever used. Further, the International Organization for Standardization (ISO), an international-standard setting body, has a set of standards for describing the physical dimensions and recording technique on identification cards which are known as ISO 7810 and 7811.

Magnetic stripe cards having these standard specifications can typically be read by point-of-sale devices at a merchant's location. When the card is swiped through an electronic card reader at the checkout counter at a merchant's store, the reader will usually use its built-in modem to dial the number of a company that handles credit authentication requests. Once the account is verified and an approval signal will be sent back to the merchant to complete a transaction.

Although magnetic stripe cards are universally used by merchants there is no way for an individual to take advantage of the card to receive a payment from another individual (who is not a merchant) by swiping the card through a simple reader attached to his cell phone. For example, one individual may owe another person money for a debt, but one way to pay the debt is to provide cash or a check. It would be convenient to be able to use a credit card or a debit card to pay off the debt. In addition, it is advantageous for an individual to make payment to another individual or merchant by swiping his magnetic stripe card through a reader connected to a cell phone. However, there is presently no way for an individual to send payment to an individual or merchant through the use of a magnetic stripe card by using a simple magnetic stripe card reader connected to a cell phone.

Therefore, it would be desirable to have a simple card reader device that would allow an individual to receive or send payment through the use of a magnetic stripe card. It is also desirable to provide a simple portable card reader device that can be connected to a cell phone with the cell phone acting as a secure point-of-sale device. The cell phone can have an application programmed therein to submit the card data to a company or a third party that handles credit authentication requests.

### BRIEF SUMMARY OF THE INVENTION

In one form of the present disclosure, a card reader device for reading a card having data stored on a magnetic stripe incorporated into the card the card reader device comprises a read head for passing a magnetic stripe of a card by to read data stored on a magnetic stripe and for producing a signal indicative of data stored on a magnetic stripe, a signal setting device for setting an amplitude of the signal indicative of data stored on a magnetic stripe, an encrypting microprocessor, and an output jack adapted to be inserted into a microphone input associated with a cell phone for providing the signal indicative of an encrypted form of the data stored on a magnetic stripe to a cell phone, wherein application software resident on the cell phone adds pertinent transaction data to the encrypted card data and transmits both to a decryption server (provided by a service entity), which decrypts the card data, decodes it and then passes all of the data to the authorizing entity indicated by the decoded information.

In another form of the present disclosure, a card reader device for reading a card having data stored on a magnetic stripe incorporated into the card, uses an amplifier for amplifying the signal indicative of data stored on a magnetic stripe, instead of the signal setting device for setting an amplitude of the signal.

In light of the foregoing comments, it will be recognized that a principal object of the present disclosure is to provide a secure card reader device comprised of a very simple external device with encryption capability to be used in conjunction with a cell phone and a decryption service.

A further object of the present disclosure is to provide a card reader device that can read and encrypt data stored on a magnetic stripe card by sensing the recorded data waveform and transmitting an encrypted data waveform to a cell phone.

Another object of the present disclosure is to provide a card reader device that can read one or more tracks of data stored on a magnetic stripe card.

A further object of the present disclosure is to provide a card reader device that is of simple construction and design and which can be easily employed with highly reliable and secure results.

A still further object of the present disclosure is to provide a card reader device that can be easily carried or stored, but which cannot be used to illegitimately obtain magnetic card data.

Another object of the present disclosure is to provide a card reader device that may be constructed in various shapes, designs, or forms.

A still further object of the present disclosure is to provide a card reader device that can amplify data read from a magnetic stripe card. In some constructions an amplifier resident in a card reader device may require power which may be provided by a cell phone.

Another object of the present disclosure is to provide a card reader device that can operate with existing magnetic stripe cards.

These and other objects and advantages of the present disclosure will become apparent after considering the following detailed specification in conjunction with the accompanying drawings, wherein:

### BRIEF DESCRIPTION OF THE DRAWINGS

FIG. 1 is a side perspective view of a card reader device constructed according to the present disclosure;

FIG. 2 is a schematic diagram of a card reader device constructed according to the present disclosure;

FIG. 3 is a schematic diagram of another embodiment of a card reader device constructed according to the present disclosure; and

FIG. 4 is a flowchart of a method of operation of a card reader device constructed according to the present disclosure.

### DETAILED DESCRIPTION OF PREFERRED EMBODIMENTS

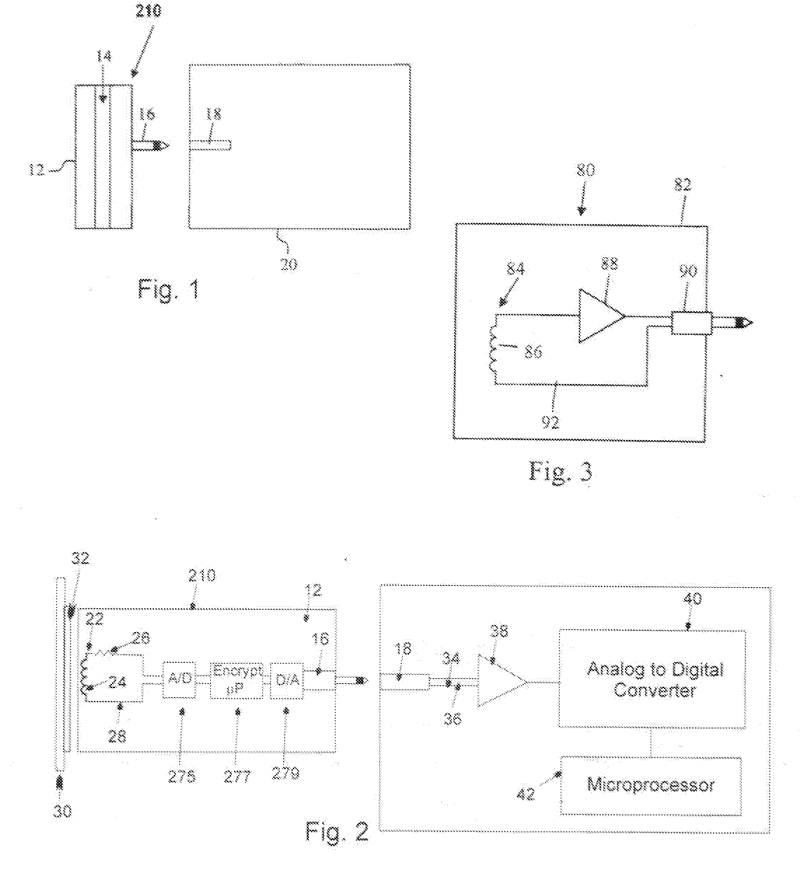

Referring now to the drawings, wherein like numbers refer to like items, number 210 identifies a preferred embodiment of a card reader device constructed according to the present disclosure. With reference now to FIG. 1, the card reader device 210 is shown to comprise a housing 12 having a slot 14 and an output jack 16 extending out from the housing 12. The jack 16 is adapted to be inserted into a socket 18 such as a microphone input or a line in audio input of a cell phone 20. The jack 16 may be a TRS (tip, ring, sleeve) connector also known as an audio jack, phone plug, jack plug, stereo plug, mini-jack, or mini-stereo audio connector. The jack 16 may be formed of different sizes such as miniaturized versions that are 3.5 mm or 2.5 mm. It is also possible and contemplated that the jack 16 may be retractable within the housing 12.

The slot 14 is wide enough and deep enough to accept a card having a magnetic stripe. In particular, the slot 14 is deep enough that the magnetic stripe will fit within the slot 14. The slot 14 also has a length that is less than the length of the card to be inserted into the slot 14. However, it is also possible and contemplated that the slot 14 may have other lengths if desired, for a given application. The housing 12 may take on different shapes and sizes, as will be discussed further herein.

FIG. 2 illustrates a schematic diagram of the card reader device 210. The card reader device 210 comprises a read head 22, such as an inductive pickup head, having a coil 24 connected to a signal amplitude setting device 26 such as a resistor which is connected to an analog to digital (A/D) converter 275. A lead 28 connects the A/D converter 275 to the coil 24 to complete the amplitude setting circuit, for passing an analog signal to the A/D converter 275. The A/D converter 275 is connected for passing the digital data to an encrypting microprocessor 277, which in turn is connected for passing the encrypted digital data to a digital to analog (D/A) converter 279. Thus the encryption process does not interfere with the electrical (analog) transmission of data from the card reader device 210 to the cell phone 20.

A card 30, such as a credit card, has a magnetic stripe 32 associated with the card 30. As has been previously discussed, the magnetic stripe 32 may have three tracks with each of the tracks containing data. The card reader device 210 is capable of reading one track, usually track two, when the device 210 is connected to the microphone input of the cell phone 20. As the magnetic stripe 32 of the card 30 is passed by the read head 22 the read head 22 reads data or information stored in the magnetic stripe 32. Although not shown, the card 30 is inserted into the slot 14 in the housing 12 and the card 30 is swiped or passed by the read head 22. Data stored in the magnetic stripe 32 may be in the form of magnetic transitions as described in the ISO 7811 standards. As the card 30 moves past the read head 22, magnetic transitions representing data induce a voltage in the coil 24. A voltage signal or waveform produced by the coil 24 is provided to the resistor 26 with the resistor setting the amplitude of the waveform. This waveform is digitally encrypted in devices 275 and 277, then converted back to an analog signal which is a new waveform indicative of an encrypted form of the magnetic stripe data, and this is sent via the jack 16 into the microphone input socket 18 of the cell phone 20. A pair of wires 34 and 36 connect the socket 18 to an amplifier 38. The amplifier 38 amplifies the waveform received from the card reader device 210. The amplified waveform is provided to an analog to digital converter device (ADC) 40 where the waveform in analog form is converted into digital samples of the analog waveform. The digital samples are sent to a microprocessor 42 for further processing, as will be explained. For the sake of clarity and brevity most of the components of the cell phone 20 have not been shown. However, the cell phone 20 may also include such components as memory including flash ROM, SRAM, a camera, a battery, LCD driver, a display, an antenna, a speaker, a Bluetooth circuit, and WIFI circuitry. The flash ROM may contain programs, applications, and/or an operating system for the cell phone 20.

The card reader device 210 is capable of being connected to the cell phone 20 for providing data stored in the magnetic stripe 32 of a card 30. Once connected any magnetic stripe 32 that is swiped in the slot 14 is read by the read head 22. The magnetic read head 22 generates an analog waveform that results from changes in magnetization along the stripe 32 relative to the movement between the read head 22 and the stripe 32. The resistor 26 sets the amplitude of this signal which is encrypted (a digital process applied to the data carried in the waveform) and then provided to the cell phone 20. This signal is then amplified by the amplifier 38 contained in the cell phone 20. The ADC 40 of the cell phone 20 samples the amplified analog waveform at a given sampling rate and generates a stream of digital values or samples. These digital samples are processed by the processor 42 that can in turn provide information to a host system (server) which can decrypt the digital data and then pass it to an entity (e.g., third party) that handles credit authentication requests. The processor 42 can communicate with the host decryption server via the cell phone network, WIFI, Bluetooth or any other mode available to it. The host system may also send a signal to the cell phone 20 to indicate that the transaction has been completed (e.g., the decryption service will relay the signal returned by the credit authentication entity).

The processor 42 may be controlled by a program or an application stored in memory or in a program storage area. For security purposes, the program or application in the cell phone is not enabled to decrypt the digital data, and therefor is not able to read or store the card information in a usable form. The decryption server can be programmed to decode the unencrypted digital data and use the decoded signals to contact an appropriate third party for authorizing a transaction. In this manner, a payment from the cardholder's account can be transferred to the account of a merchant that accepts credit card transactions. The merchant's account identification may be programmed into the cell phone or otherwise tied to the specific cell phone being used. The cell phone may send its identification information along with the encrypted card information, and the decryption server could link the phone with a predetermined merchant's account.

With reference now to FIG. 3, another embodiment of a card reader device 80 is illustrated. The card reader device 80 comprises a housing 82 having an inductive read head 84 with coil 86 connected to an amplifier 88 which is connected to an output jack 90. The output jack 90 extends out of the housing 82 and is adapted to be inserted into a line in audio input or a stereo line in input associated with a cell phone (not shown). A wire 92 connects the jack 90 to the coil 86. Although not shown in this particular drawing, a slot is formed in the housing 82 near the coil 86 to allow a card having a magnetic stripe to be passed by the coil 86. Data or information stored in the magnetic stripe is read by the coil 86. The coil 86 produces a waveform indicative of data stored in the magnetic stripe and this waveform is provided to the amplifier 88. The amplified waveform is then transmitted to the cell phone via the jack 90. The amplified waveform may be provided to an ADC device for converting into digital samples to be processed by a microprocessor in the cell phone, and then sent to the decryption server and so on, as described hereinabove.

Given the encryption circuitry (device components 275, 277, 279) illustrated and described hereinabove for the card reader device 210, it should be obvious that equivalent circuitry (doubled for stereo signals) can be easily added to the card reader device 80 between the amplifier 88 and the output jack 90, thereby encrypting the card data that is indicated by the analog signal waveform which is passed to the cell phone.

Since the card reader device 80 uses the line in audio input of the cell phone, the card reader device 80 is capable of transmitting two tracks from the card being read. As has been previously discussed, a magnetic stripe may have up to three tracks with each of the tracks containing data. For example, the card reader device 80 may read tracks one and two and send these signals to the cell phone as the left and right channels of a stereo signal. However, with the card reader device 80 any two of the three tracks, usually tracks one and two, may be read and encrypted by the card reader device 80 and passed to the cell phone when the jack 90 is connected to the stereo line in inputs of the cell phone. In some situations or constructions, it is possible that the amplifier 88 may need to be powered. The amplifier 88 may be powered from a power source resident in the cell phone to which the device 80 is connected. In like manner, the A/D converter 275, the encrypting microprocessor 277, and the D/A converter 279 may be powered as needed.

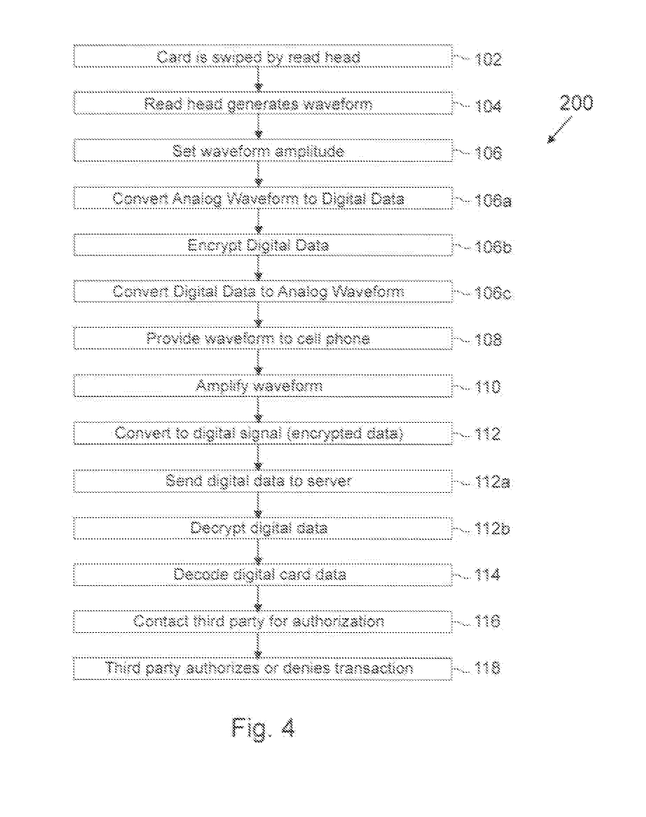

FIG. 4 illustrates a flowchart diagram of a method of operation 200 of the card reader device 210. The method 200 begins operation at a step 102 in which a magnetic stripe card 30 is swiped through the slot 14. In a next step 104, the read head 22 reads data stored in the magnetic stripe 32 and generates an analog signal or waveform indicative of data stored in the magnetic stripe 32. The waveform then has its amplitude set by the resistor 26 in a step 106.

In a next step 106a, the A/D converter 275 converts the waveform to digital data (e.g., samples) which is in suitable form for encryption by the encrypting microprocessor 277 in the next step 106b. Then, in step 106c, the D/A converter device 279 converts the encrypted digital data into an analog signal waveform so that the encrypted data from the card can be passed through the output jack 16 into the analog circuitry of the cell phone.

Next, in a step 108, the waveform is provided to the cell phone 20 via the output jack 16 through the socket 18. In a next step 110, the amplifier 38 amplifies the waveform. The waveform is provided to the analog to digital converter device 40 for conversion to a digital signal in a step 112.

Next, in step 112a, the cell phone sends the still-encrypted digital data to a decryption server, where, in step 112b, the digital data is decrypted to become a clear digital data string. Then the decrypting server decodes the digital card data (signal) in a step 114.

In a next step 116, the decrypting server contacts a third party, determined according to the decoded data, to authorize a transaction using the decrypted and decoded data. The third party either authorizes or denies the transaction in a last step 118.

For example, if the third party authorizes the transaction then money deducted from the account of the cardholder is transferred into an account associated with the cell phone owner or vice versa. In this way, a debt can be collected or paid by use of the card reader device 210. Further, the card reader devices 210 or 80 may be employed to transact a one-way transaction in which money can be credited to an account. In essence, the card reader devices 10 or 80 allow a user to become either a micro-merchant (payee) or a customer (payer) without having to purchase expensive card reader devices or software.

Furthermore, security measures that are normally built into the prior art expensive card reading devices/software are now also built into the miniaturized card reader device that is improved by adding a card data encryption device such as the device components 275, 277, and 279 shown (in FIG. 2) built into the improved/secure card reader device 210, and also shown implemented in the method 200.

In a preferred embodiment of the security measures, the encryption microprocessor 277 is programmed (e.g., in firmware) such that it will encrypt the digital data using a PGP public key which corresponds to a private key held by the decryption server(s). PGP encryption is very secure, and can only be decrypted by a processor which is using the private key which was created as a mate to its corresponding public key. Presumably the entity that creates and distributes the encrypting card readers (e.g., reader 210) also controls and/or provides the decrypting servers as a cloud based service. Thus the decrypting service is an extra link inserted into the chain of credit card processing steps.

Other shapes, sizes, or designs for the card reader devices 210 or 80 are possible and contemplated.

From all that has been said, it will be clear that there has thus been shown and described herein a card reader device which fulfills the various objects and advantages sought therefore. It will become apparent to those skilled in the art, however, that many changes, modifications, variations, and other uses and applications of the subject card reader device are possible and contemplated. All changes, modifications, variations, and other uses and applications which do not depart from the spirit and scope of the disclosure are deemed to be covered by the disclosure.

What is claimed is:

1. A card reader device for securely reading a card having data stored on a magnetic stripe incorporated into the card, the device comprising:
a read head for passing a magnetic stripe of a card by to read data stored on a magnetic stripe and for producing a signal indicative of data stored on a magnetic stripe;
an encryption microprocessor for encrypting the signal; and
an output jack adapted to be inserted into a microphone input associated with a cell phone for providing the encrypted signal indicative of data stored on a magnetic stripe to a cell phone.

2. The card reader device of claim 1 further comprising:
an analog to digital converter for converting the signal to digital data for encrypting in the microprocessor; and
a digital to analog converter for converting the encrypted digital data to an analog signal for providing the signal to the cell phone.

3. A card reader device for securely reading a card having data stored on a magnetic stripe incorporated into the card the device comprising:
a read head for passing a magnetic stripe of a card by to read data stored on a magnetic stripe and for producing a signal indicative of data stored on a magnetic stripe;
an amplifier for amplifying the signal indicative of data stored on a magnetic stripe;
an encryption microprocessor for encrypting the signal; and
an output jack adapted to be inserted into a microphone input associated with a cell phone for providing the encrypted signal indicative of data stored on a magnetic stripe to a cell phone.

4. The card reader device of claim 3 further comprising:
an analog to digital converter for converting the signal to digital data for encrypting in the microprocessor; and
a digital to analog converter for converting the encrypted digital data to an analog signal for providing the signal to the cell phone.

5. A method for securely reading a card having data stored on a magnetic stripe incorporated into the card, the method comprising the steps of:
providing a card reader device comprising a read head for producing a signal indicative of data stored on a magnetic stripe, an encryption microprocessor, and an output adapted for electrically connecting to a cell phone input;
providing a cell phone comprising circuitry for processing a signal indicative of data;
electrically connecting the card reader output to the cell phone input;
passing a magnetic stripe of a card by the read head to read data stored on the magnetic stripe and to produce a signal indicative of the data;
using the encryption microprocessor to encrypt the data indicated by the signal;
providing a signal indicative of the encrypted data to the cell phone for processing to extract the encrypted data, being an encrypted form of the data read from the magnetic stripe.

6. The method of claim 5, further comprising the steps of:
sending the encrypted data to a decryption server that is secure and separate from the cell phone;
decrypting the encrypted data to obtain a clear digital data string indicative of the data stored on the magnetic stripe.

7. The method of claim 6, further comprising the steps of:
using a pair of encryption keys such that only a decryption server can decrypt data that has been encrypted by the encryption microprocessor of a card reader device.
